(19) United States
(12) Patent Application Publication
(10) Pub. No.: US 2012/0244500 A1
(43) Pub. Date: Sep. 27, 2012

(54) SYSTEM AND METHOD FOR DETECTING LEADERSHIP

(75) Inventors: Maria-Cristina V. Marinescu, Madrid (ES); Vadakkedathu T. Rajan, Briarcliff Manor, NY (US); Mark N. Wegman, Ossining, NY (US)

(73) Assignee: INTERNATIONAL BUSINESS MACHINES CORPORATION, Armonk, NY (US)

(21) Appl. No.: 13/070,116

(22) Filed: Mar. 23, 2011

(51) Int. Cl. G09B 19/18

(52) U.S. Cl. 434/107

(57) ABSTRACT

A system, method and computer program product for detecting leadership in a socio-technical environment based on the chronologic distribution of artifacts. The system and method captures and makes use of chronologic information as a predictor of causality in the dissemination of artifacts. A measure of leadership is based in part on the amount of relevant artifacts generated as a result, and temporal causality is used to detect this. The system method and computer program product further determines the patterns of behavior that govern a socio-technical context. By defining a set of patterns and comparing them with the interactions observed within a socio-technical network issues are discoverable.

### BACKGROUND

The present invention relates generally to organizations, and particularly, to a system and method for determining who are leaders of an organization.

Detecting leadership in an organization is a factor in understanding what communication channels are broken and need to be established within the organization, as well as whether the organizational structure in place is a good match for the existing mechanics of communication. For example, detecting who are the leaders of an organization at a given time can be instrumental in detecting important communication breakdown, as well as understanding whether an existing organizational structure facilitates the type of communication that naturally arises in a group.

It would be highly desirable to provide for a system and method for determining who is a leader in an organization.

It would further be highly desirable to provide a system and method for associating leadership weights with each individual in the organization, and which can be used in determining who is(are) leader(s) in an organization.

It would be further highly desirable to provide a system and method for extracting leadership patterns and determining problematic behavior related to leadership.

### SUMMARY

A system, method and computer program product for defining a dynamic notion of leadership within an organization, the notion of leadership being based on chronology and the amount of work that distinct actions create. In one aspect, the system and method detects who is a leader in an organization, and associates leadership weights with each individual in the organization.

In one aspect the system, method and computer program product defines a set of leadership patterns and the context in which they may be a symptom of problematic behavior within the organization. That is, the system and method implements extracting leadership patterns and determining problematic behavior related to leadership.

In a further aspect, there is provided a method for determining the patterns of behavior that govern a socio-technical context. In one embodiment, for example, by defining a set of patterns and comparing them with the interactions observed within a socio-technical network issues such as: missing paths between a leader and the individuals affected by the leader's actions, too much or too little control, too many contradicting or defocusing ideas, too little critical thinking, too few idea exchange, etc., are discoverable.

In this aspect, the patterns of behavior are provided such as those interaction patterns that naturally arise in an organization, or at least, supported by the organizational structure.

There is thus provided, in one aspect, a system and method for detecting who is a leader in an group of individuals comprising: collecting data regarding interactions between individuals in the group; and, for each individual i in the group and for each individual j who interacts with individual i, and, for each interaction between i and j, computing a relative leadership score λᵢⱼ describing a relationship between a leadership score lᵢ corresponding to individual i and, leadership score lⱼ corresponding to individual j, and, computing, based on the relative leadership scores, an individual leadership score lᵢ, lⱼ corresponding to each individual i and j, a leader of the group determined as an individual having a largest leadership score at a given time, wherein a program using a processor unit executes one or more the collecting, computing and determining.

Further to this aspect, the computing of a relative leadership score λᵢⱼ comprises: computing a contribution of each interaction to the relative leadership score as a function of a time period t_{sender, recipient} in which recipient j responds to an interaction initiated by sender i.

Further, the computing a relative leadership score λᵢⱼ comprises: computing a contribution of each interaction to the relative leadership score as a function of an average response time θ_{recipient} in which the recipient j responds to all interactions initiated by senders.

The computing of a relative leadership score λᵢⱼ may additionally comprise: determining a weight contribution of each interaction to a relative leadership score between individual i and j, the λᵢⱼ representing an average weight over all the interactions between individuals i and j.

Further to this aspect, the determining of leadership scores comprises: iteratively processing a set of linear equations in to minimize a difference between lᵢ and lⱼ, where lᵢ≈λᵢⱼ lⱼ.

Moreover, in this aspect, an action by an individual comprises one or more of: an e-mail communication to a recipient, a chat initiated with recipient, or phone interaction with recipient, or, a creating or changing of a software artifact, the method further comprising: determining whether the interaction is sending an email and recording the time the message was received in a recipient's e-mailbox or voice mailbox; or, determining whether the interaction is the creation or change of some software artifact and recording the time that the artifact is committed to the public domain.

Further to this aspect, after determining an individual in the entity who exhibit leadership, the method further comprises: observing that individual's interaction patterns within the entity and comparing them with a pattern involving leadership, and reporting information about the comparisons.

In another aspect, a computer program product is provided for performing operations. The computer program product includes a storage medium readable by a processing circuit and storing instructions run by the processing circuit for running a method. The method is the same as listed above.

### BRIEF DESCRIPTION OF THE DRAWINGS

The objects, features and advantages of the present invention will become apparent to one skilled in the art, in view of the following detailed description taken in combination with the attached drawings, in which:

FIG. 1 depicts an exemplary flow chart depicting a method 100 for determining/detecting leadership within an organization;

FIG. 2 depicts one exemplary method 200 for detecting the occurrence of problematic behavior;

FIG. 3 depicts, in one example embodiment, a method 300 to detect an emergence of a “churn” pattern;

FIG. 4 depicts an exemplary hardware configuration for performing methods such as described in FIGS. 1-3 in one embodiment.

### DETAILED DESCRIPTION

In one aspect, by observing the temporal distribution of action/responses during an interaction between individuals in an organization and recording these as a set of artifacts, it may be determined who is the individual that has the most impact on the interaction. For example, this may be one individual whose actions are responded to the quickest by a significant number of other individuals; and, someone which elicits this type of behavior may be referred to as a leader.

Thus, in one aspect, detecting who are the leaders of an organization is by implementing a technique based on the analysis of timestamps embedded in software artifacts.

One example embodiment of leadership is the case in which the artifacts generated by a particular person result in a high number of subsequent artifacts being produced by a significant number of the members in the same organization, within a short period of time. An instance of this can be found in the context of email transaction. Specifically, recipients may not be responsive—at least not immediately—to a given email. But if a leader responds to the email, it may be that with high probability the rest of the recipients will answer as well.

Thus, the system and method recognizes that the person whose email started a series of responses is a leader and not the person that sent the original email. The prediction is made based on the temporal closeness of many of the responses to the leader's email rather than the originating one.

However, it is noted that one example notion of a leader is different from a notion of a leader being a most-connected person in an organization, and it is a dynamic notion.

For example, leadership can change over time; also, there may be several different leaders at the same time. A situation in which the leader changes over time is illustrated, e.g., by a process of testing a product before release. Employees will focus their effort on fixing the most important existing problem; each such issue is within the expertise of one leader. As the problem gets fixed and the focus moves onto a different issue, the technical leader will often also change.

As a further example, in a development phase though a project is usually split into several pieces and though members may work on more than one piece at a time, there is usually one person which is the leader for each of the different technical fields involved. The number of responses of the other individuals to the multiple leaders may be very different depending on the cardinality of the class including individuals active in the leader's field. Nevertheless it is desirable to recognize that there are, in fact, multiple leaders.

One example way to construct these classes is to define an ontology of concerns for the organization or project under study and record the content type of the action/response. Based on the additional content information, it can be determined whether two interactions (i.e. sets of transitively connected action/responses) are, or not, concerned with the same domain of interest or expertise, and therefore whether they should both be considered in determining the leader.

Further, one notion of leadership can correctly handle scenarios in which a static notion based on a most centrally connected individual would arrive to an erroneous conclusion. A leader such as the head of a research division may not directly interact with more than the individuals in his immediate hierarchic vicinity. He is therefore not the most connected individual in the division, but if an email he sends receives many more quick responses than any other individual's then it is reasonable to consider him a leader.

Thus, in one non-limiting aspect, examples of common scenarios supporting the notion of leadership as described herein include: Leaders who are not centrally connected; Leaders who don't initiate the interaction; Multiple leaders; Changes in leadership; The relative weight of individual action/response pairs; Transitivity in leadership; and, Aquaintenceship.

For example, for the case of an operationally excellent organization with a deep hierarchical structure, the most probable individual to be the leader is the person at the top of the hierarchy as this person will most probably communicate with the individuals immediately, or closely below him in the hierarchy. He will not directly connect to the people that are responsible for executing on his decisions. An individual lower in the hierarchy who manages a lot of employees can effectively be more “centrally connected” than the leader in the sense that he knows and interacts directly with more people. He is nevertheless neither someone who advances ideas nor someone who the others listen to the most, nor is he the decision maker.

Thus, a static notion of leadership which is based on how well connected an individual is may wrongly identify this person as the leader. The definition of leadership as described herein makes it possible to detect the real leader based on the response time to the leader's action and the leadership weight of the respondents.

Thus, in an example of a centrally connected person in an organization: assume that that person is at the top of the power hierarchy and therefore is at distance “1” from all the managers who report directly to that person, and at distance “2” from all their directly managed people, and so on. It is further assumed that the person at the top of the hierarchy initiates interactions via email with people which are part of different management branches and also unrelated projects. If only one interaction is viewed at the time, being unaware of the rest of the people in the organization leaves the initiator in a peripheral position with regard to the number of connection he has to the rest of the organization. The method of the present invention detects this person as a leader because it is based on the impact that this person has on the other individuals—in this case response time and volume—as opposed to connection diameter.

As an example of a leader who does not initiate the interaction, many interactions start with an individual who is not a leader taking an action, e.g., by sending an email about an idea he wants to pursue and trying to get other people interested in it. Assume one of the people he sends email to is a recognized leader in the organization. For some time the initiator of the action gets no response to his email, but then the leader finds the idea interesting and sends a reply. What most often happens in such a case is that the other people on the original mailing list notice the leader's email and very quickly start responding, usually to the leader's email rather than the initial one. Even though it isn't the leader who had the idea and initiated the discussion, it is because of his response that the other people in the organization started participating in the interaction.

Thus, the method of the present invention detects this person as a leader as it is possible to adjust the method such that, even in the eventuality that people will respond to the initiator instead of the leader, the leader will be correctly recognized based on the fact that the many responses started very quickly after he responded rather than after the original email itself.

Moreover, each individual is generally involved in more than one interaction, and often there is more than one type of interaction in which the individual may fill a different role. For example one may be involved simultaneously in a work project, in discussing the details of a group trip, and in an email exchange with his wife. He may be the leader in organizing the trip, but not in the work project. Similarly the fact that he may answer very quickly to email from his wife does not necessarily make her a leader; that may be of course a possibility if, with regard to the subject of the email, a lot of the people will answer very quickly and contribute their leadership weights to hers. In the development phase a project is usually split into several pieces and though members may work on more than one piece at a time, there is usually one person which is the leader for each of the different technical fields involved. The number of responses of the other individuals to the multiple leaders may be very different depending on the cardinality of the class including individuals active in the leader's field. Nevertheless the invention recognizes that there are, in fact, multiple leaders. A good way to construct these classes is to define an ontology of concerns for the organization or project under study and record the content type of the action/response. Based on the additional content information, it can be determined whether two interactions (i.e. sets of transitively connected action/responses) are, or not, concerned with the same domain of interest or expertise, and therefore whether they should both be considered in determining the leader.

A notion of a leader as a static concept is not realistic in organizations with a more flexible structure, organizations focused on product innovativeness, as well as in other many circumstances. The definition of leadership according to the present invention is dynamic and evolves in time; one can be a leader today but not next month depending on the change in focus of the organization. A situation in which the leader changes over time is well illustrated by the process of testing a product before release. Employees will focus their effort on fixing the most important existing problem: suppose that each such issue is within the expertise of one leader. As the problem gets fixed and the focus moves onto a different issue, the technical leader will often also change.

In a further example, the relative weight of individual action/response pairs is used to determine notion of leadership. For example, assume an idea is proposed by an individual for a new project at work, and that individual's boss's boss thought it will solve some problem the company was having for a long time. A response from him will add much more weight to that individual's leadership score than that individual's colleague having the same reaction. That is, that individual becomes “more of a leader” the more leaders that respond to that individual. Ultimately a leader is someone who makes other people get things done.

Thus, in a further aspect, the invention evaluates responses based on their relevance. One example way to achieve this is mining the text of the response (text-mining), or, establishing causality between an action and the completion of tasks, etc. In the absence of such complex analysis, the relevance of an action/ response pair is measured by the relative weight of the responder vs. the action taker.

With respect to transitivity in leadership, this is exemplified by a developer A who chooses to reuse a specific implementation of some functionality by inheriting code from one other developer, B. Developer B is building the functionality needed by Developer A by reusing code from two developers, C and D. By transitivity, Developer A is reusing code from C and D as well; therefore Developer A is not only responding to Developer B by using his code and increasing his leadership weight, but also to Developers C and D, although only with half weight contribution to each.

With respect to aquaintenceship in leadership, this refers to whether one knows somebody on a personal level, or has worked well with that somebody before, or one who is having regular email exchange influences whether one responds to that somebody's actions. Thus for example, a leadership weight added by responding to that person's action is reduced the more interactions one has had in the past.

There are many other factors that influence individual's responses to a given action. Conflict of interest, scarce resources, competition, etc, can all be factors that influence a negative response to an action. A colleague who is competing with a person for resources for his/her project may answer very quickly to that person's actions, though the colleague may not have any interest that the other person has a large leadership impact. The colleague may in fact want to point out problems with that person's idea so that it dies before other people pay too much attention to it. A colleague's response to that action may be calculated to optimize for this. These factors may be incorporated as part of the formula computing the leadership weights.

Detecting who are the leaders of an organization at a given time is instrumental in detecting important communication breakdown, as well as understanding whether the existing organizational structure facilitates the type of communication that naturally arises in a group.

In the system, method and computer program product, detecting leadership is described herein by way of example. The example considers a case that a person sends an e-mail to a group seeking to start a discussion. If the sender of the e-mail is not seen as a leader, the recipients would tend to glance at the e-mail and set it aside with an intention of dealing with it after more pressing demands are met. Often this means that the recipient never responds to that e-mail. If, however, the sender is a well respected person in the organization, e.g., a “leader”, then the e-mail receives more careful thought often leading to a prompt response. If the group has a significant number of members who respect this individual, it can lead to a lively discussion. While the time and number of responses are a random variable influenced by many factors, the leadership status of the person sending the e-mail has a significant impact on the response time. For example, a leadership score may be generated for association with each person in the organization, and the time it takes for recipient to respond is a function of the relative leadership score of the sender and the receiver. One formulation assumes that if the recipient responds in a time

t_{sender, recipient}
and the average response time of the recipient to all e-mail he/she receives is θ recipient
then a measure of the relative leadership score is given by:

l_{sender}=l_{recipient}f(t_{sender, recipient}/θ_{recipient}) (1)

This is just one possible way to weigh the relative leadership scores of two persons. It can be inferred the relative leadership score from parameters of the various interactions, such as e-mail, chat, phone interactions. Thus, generally, a measure of the relative leadership score is given by:

l_{sender}=l_{recipient}f(various observed parameters)

As there could be a large number of such interactions, there is calculated an average weight over all such interactions between a given sender and recipient. Thus the method can average over the interactions and obtain a relationship as in equation (2):

lᵢ≈λᵢⱼ lⱼ (2)

where λᵢⱼ is the average weight over all the interactions between i and j and is referred to herein as a relative leadership score.

In addition, in one embodiment, the leadership score is normalized, requiring that the leadership score tends to a value one “1”. Given the above relationship between sender and recipient for a significant subset of pairs of individuals in an organization, the leadership scores that best fits the above set of equations are found. There may not be a solution that satisfies the above equations exactly, since there are in general a quantity “ n” l_{sender} variables and O(n²) interactions.

Furthermore, while there may be no solution to the above equations, a relative leadership score λᵢⱼ can be computed that comes closest to satisfying above relationship. That is, the squared error in the above relationships can be minimized. Thus, associating a weight wᵢⱼ with each of the relationships results in the following relation:

$${Min}_{li} {\sum }_{ij} {{w}_{ij} ( {l}_{i} - {λ}_{ij} {l}_{j} )}^{2} + {\sum }_{i} {( {l}_{i} - 1 )}^{2} \qquad ( 3 )$$

In the relation set forth in 3), weights wᵢⱼ are chosen to take into account that some interactions are strong and therefore deserves full weight, while other interactions are weak, may involve only few or rare interactions, and hence deserving less weight. Given nᵢⱼ as the number of interactions between an individual i and individual j, the leadership weight may be chosen according to:

wᵢⱼ=nᵢⱼw₀/(nᵢⱼ+n₀) (4)

where n₀ is a constant, e.g., an integer or real number. For example, this constant n₀ may be taken to be the same (i.e., constant) for all the participants or, the constant is different for each participant (e.g., the average for each participant). When the number of interactions is small, the weight increases linearly with the number of interactions, but it reaches a saturation value of w₀ when the number of interactions is much larger than n₀.

The minima of the equation 4) can be determined by differentiating which yields a set of linear equations in lᵢ which are processed to determine the leadership scores. The linear equations are:

$${l}_{k} ( {\sum }_{j = 1}^{j = n} ( {w}_{kj} + {w}_{jk} {λ}_{jk}^{2} ) + 1 ) = 1 + {\sum }_{i = 1}^{i = n} ( {λ}_{ki} {w}_{ki} + {λ}_{ik} {w}_{ik} ) {l}_{i} \qquad ( 5 )$$

where k=1, . . . n are a set of n equations which can be solved for the n unknowns, lᵢ, i=1, . . . n. This system of equations in 5) is solved iteratively by starting with an lᵢ initialization, e.g., lᵢ=1 and then solving for the new value of lₖ on the left hand side of eq. 5) by using the old values of lᵢ on the right hand side.

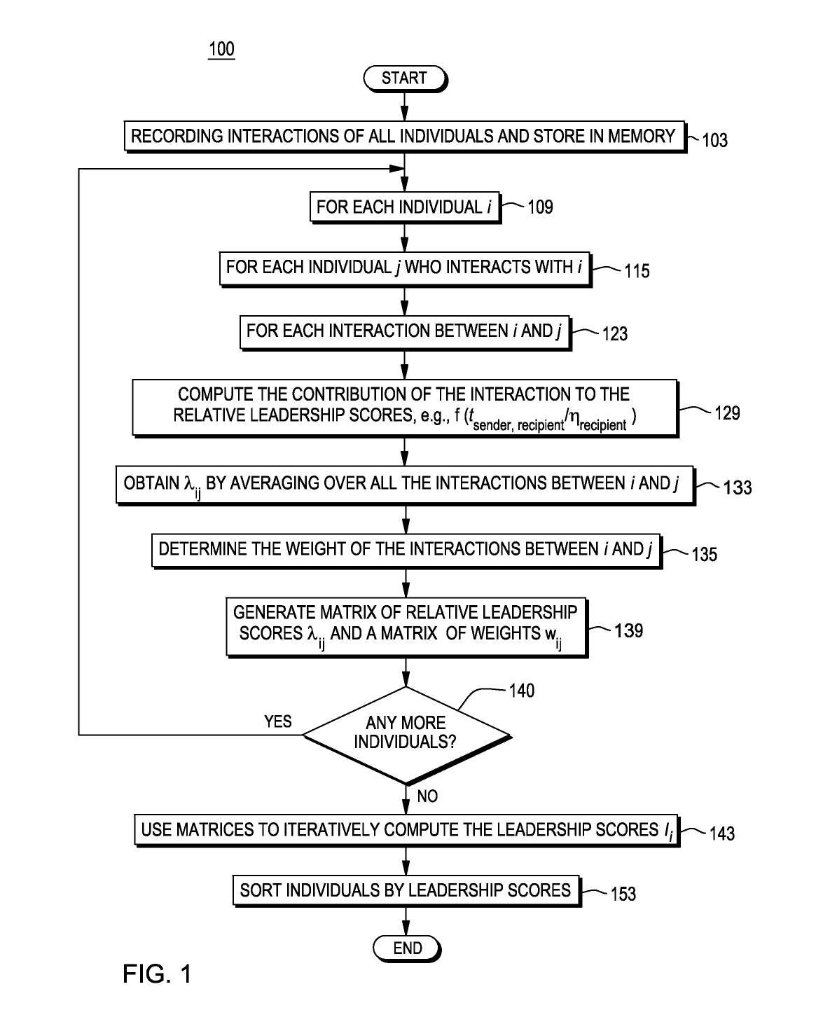

FIG. 1 is a flow chart depicting method 100 steps for detecting who are leaders in an organization. A first step 103 is recording, by a computer, all interactions among individuals. In one example, this may include recording all e-mail interactions individuals i takes. This data of recorded individuals' interactions (e.g., e-mails between sender i and recipients j) may be stored in a database. Then, at 109, 115 and 123 respective WHILE or FOR-DO loops are entered to compute, at 129, for each individual i in the database (at 109) and for each person j who interacts with i (at 115) and for each interaction between i and that individual j (at 123), e.g., where i is a sender and j is a recipient), the contribution of the interaction to the relative leadership scores: In one example, the computation at 129 involves computing the function such as shown in equation 1):

λᵢⱼ=f(t_{sender, recipient}/θ_{recipient}=f(tᵢⱼ/θ_{recipient})

where tᵢⱼ represents the time it takes the individual recipient, e.g., individual j, to respond to an action of the sender, e.g., individual i, and θ_{recipient} is the recipient's average response time. A computer device operatively connected tied to the user's e-mail system is implemented to record these times.

In one embodiment, a determination may be made as to whether the action is a response to a previous action by individual j. If the action is a response to a previous action by individual j, then the a computer device computes the time it takes the individual to initiate a response is according to:

tᵢⱼ=t₁−t₃

where t₁ is the time the action commenced (e.g., sending an e-mail by individual sender i), and time t₃ is the recorded time the 2^{nd} individual (individual i) observes the action.

Otherwise, it may be first determined that this action of individual i is not a response to a previous action by individual j in which case, a computer records the time (t₁) that the individual's action started, and a time (t₂) that the individual's action became observable to each of the other individuals. For example, if the action is sending an email, then the computer records the time t2 the message was received in the recipient mailbox. If the action is the creation or change of some software artifact then the computer will record the time that the artifact was committed to the public domain. In this embodiment, a second individual observes the action and the computer records the time (t₃) that the second individual observes the action. The time it takes the second observer to notice the first individual's action is T_{obs}=t₃−t₂ which calculation may be additionally performed, e.g., at step 129.

In one embodiment, the λᵢⱼ=f(t_{sender, recipient}/θ_{recipient})=f(tᵢⱼ/θ_{recipient}) may be governed according to an exponentially decaying function, e.g.,

λᵢⱼ=f(x)=e^{(-x)}, where (x) is (tᵢⱼ/θ_{recipient}).

Thus, for example, in this manner, a relative leadership score of a sender, e.g., individual i, is computed lower as the recipient, e.g., individual j, takes longer to respond.

Next, at step 133, the system calculates the relative leadership scores λᵢⱼ by averaging over all the interactions between i and j.

Continuing to step 135, there is then determined the weight of the interactions between i and j. That is, based on tᵢⱼ, the computer updates the leadership weights wᵢⱼ according to equation 4) herein above.

wᵢⱼ=nᵢⱼw₀/(nᵢⱼ+n₀)

At this point, as indicated at 139, FIG. 1, there is generated a (possibly sparse) matrix of relative leadership scores λᵢⱼ and a matrix of weights wᵢⱼ.

Continuing at step 140, FIG. 1, there is then determined whether all interactions for that individual i have been recorded, or, if there are updated interactions between individuals to record. If there are additional interactions, the process returns to step 109, where additional interactions between individuals i and j are recorded and the processing from steps 115-139 are repeated.

At such time that there are no further interaction updates, e.g., no additional interactions with individual i, then from step 140, the process proceeds to step 143, FIG. 1, where the two matrices are then used to solve for the leadership scores lᵢ. In one embodiment, the scores are computed using equation (5) herein above, e.g., where equation 5) can be solved iteratively by commencing with lᵢ=1 for all the leadership scores. Then, old values are used on the right-hand side of equation 5) and lᵢ is then solved on the left hand side for the new values of lᵢ. These iterations are repeated until the new values are close to the old value.

Then, as indicated at 153, FIG. 1, once all the leadership scores are determined, the individuals are sorted by their leadership scores. The highest leadership score(s) represents possible leader(s). In other embodiments, there may be determined the highest leadership scores in a department or other subgroups, e.g., to determine leaders within each subgroup(s).

In addition to the response time, there are several other factors which may influence the relative leadership scores λᵢⱼ, such as the following including, but not limited to: the size of the response, excluding history; the number of people an email gets forwarded to; the number of attachments; whether the email was responded in the order of receiving; the T_{obs} time it takes the second observer to notice the first individual's action; whether the was email received as part of a “chunk” or is it an isolated email; whether an individual was successful in changing the interaction subject; and, whether a response is positive or negative (text mining may be implemented to account for these factors); the timing of responses relative to specific emails within the interaction; the specific concern of the interaction, for example, if I am a leader at work but a follower in making trip plans then it makes sense to separate the interactions about work from the ones concerning trips and determine a leader for each of them; and, the degree of aquaintenceship of the action taker and the responder (e.g., as a first approximation this could be the number of interactions they have had in the past).

Further factors which may influence the relative leadership scores λᵢⱼ include, but are not limited to: the amount of individuals that the email was sent to and whether these individuals are leaders; whether the responder's leaders have already answered to the action taker; the number of “hops” there are there between the action taker and the responder; and, for example, whether an individual A is using code written by individual B which uses code written by individual C then A is using both B's and C's code—in which case individual A contributes to both B's and C's leadership weights, although not in the same degree.

Depending on the specific context under study, e.g. email logs vs. forums vs. CVS repositories, etc., some of these parameters are more important than others. In one embodiment, the weight of the parameters is expected to vary and may also depend to a certain extent on user-specific patterns.

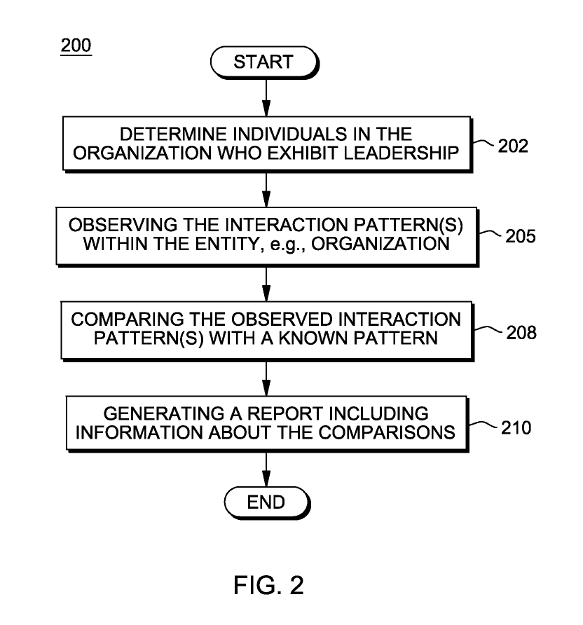

In a further aspect of the invention, functionality is provided for determining problematic behavior related to leadership then presents a specific method to detect one common particular pattern of leadership. FIG. 2 depicts one exemplary method 200 for detecting the occurrence of problematic behavior: First, at 202, determining individuals in the entity, e.g., business organization, who exhibit leadership or, alternately, associate a leadership weight with each individual in the organization. Then, at 205, there is performed observing the interaction patterns within the organization and, at 208, comparing the observed interaction patterns with a known or pre-determined pattern involving leadership. Finally, at 210, there is performed generating a report including information about the comparisons.

### Leadership Pattern

As defined herein, a notion of a leader is an individual who is either statically designated to fulfill this role or someone who dynamically emerges to be one. Examples of a static type of leader are: most centrally connected people in an organization, decision makers, sponsors, etc. A dynamic notion of a leader includes, but must not be restricted to, the chronologically-based notion of a leader that was previously defined. A leadership pattern is any pattern involving leadership which is found useful and applicable. More particularly, a leadership pattern is a statistically relevant occurrence of a temporal (direct or indirect) interaction sequence involving at least one leader. By defining a set of leadership patterns—or incorporating existing ones—and comparing them with the interactions observed within an entity, e.g., business organization, issues may be uncovered such as: missing paths between a leader and the individuals affected by the leader's actions, too much or too little control, too many contradicting or defocusing ideas, too little critical thinking, too few idea exchange, etc. In one embodiment, there is now defined several leadership patterns that are problematic in specific contexts.

For example, one pattern, referred to herein as “churn”, represents one or multiple leaders performing a sequence of actions and responses are elicited which cancel at least part of the previous responses. As a result of too many uncoordinated actions the organization may lose focus and some individuals do not finish work tasks in time.

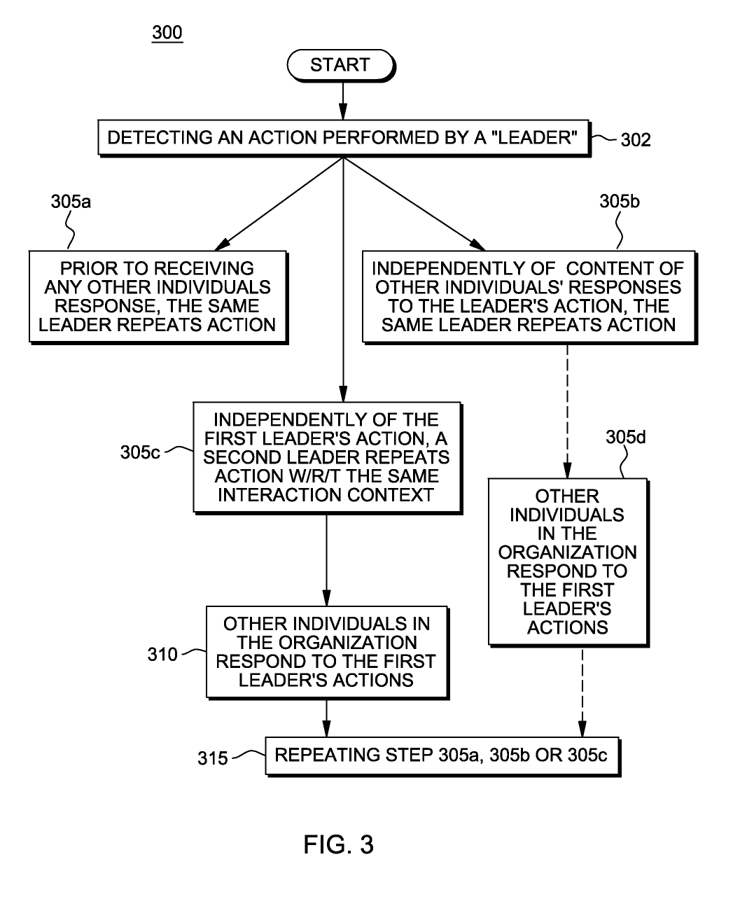

FIG. 3 shows, in one example embodiment, one method 300 implemented by network of computers and/or a host server, to detect an emergence of a churn pattern. This detecting is performed by observing the actions of leaders and signaling the following sequence associated with tasks that are not finished in time: In the embodiment shown in FIG. 3, the sequence includes: 1) a leader takes an action (e.g., a communication event) at 302; and one of: 2A) before other individuals in the organization have a chance to respond, the leader repeats step 1 at 305a, or, 2B) independently of the content of other individuals' responses to the leader's action, the leader repeats step 1 at 305b, or 2C) independently of the first leader's action—i.e., not as a response to the first leader's action—a second leader repeats step 1 with regard to the same interaction context at 305c. Then, 3) at 310, or possibly concurrently with steps 2A-2C at 305d, other individuals in the organization respond to the first leader's actions; and, then 4) repeating at 315 either of the actions of steps 305A-305C. In an example implementation, the communication events are e-mails, in one embodiment. A “conversation” may be defined as e-mails (communication events) that are replies to each other, which, in one embodiment, is based on the e-mail subject line.

Thus, in an instance when the leaders' actions are independent of the responses they get, they still have a central focus and push the interactions in the same productive direction. In one example scenario, it follows then that the lack of a meaningful two-way interaction may lead to churn problems. The opposite scenario can be true as well, i.e., an interaction pattern in which actions and responses follow each other in a chronologically logical order does not imply that a leader cannot take a contradicting action even if he/she had read the other individuals' responses and is responding to them. To get a more precise insight into whether this is the case, additional text mining is performed.

For the beginning, the churn pattern detects a mode of interaction which generally signals a lack of a two-way interaction in which one or more leaders keep taking unrelated, if not contradictory actions. It also requires observing that individuals involved in this interaction type do not finish their work tasks in time. Leaving tasks unfinished may of course not be due to an unfocussed interaction with the leader and other individuals, but may be the case much more often than not.

In one aspect, there are different types of good and bad leadership patterns depending on the strategy employed by an organization. The types of strategies considered are: (1) operational excellence, (2) product innovativeness, and (3) customer intimacy. For example, it is expected that, in an operationally excellent organization, the structure is to be more hierarchical. Further, while it is expected that a leader is most commonly an individual high in the power structure, it is not anticipated that the leaders will change much from project to project. The lack of a leader in an interaction, or the lack of communication between him and the people accountable, and transitively, responsible for the success of the project, are obvious leadership problems that must be reported.

Note that these may be less of an indication of a problem in a product innovative organization where, in this example organization type, a lot of ideas arise bottom-up and individuals have a lot more freedom to follow their ideas without strict control from a leader. Also, leaders change much more frequently depending on their technical expertise and specific projects, and a certain degree of churn is expected and even desired as too much control can squash new ideas too early.

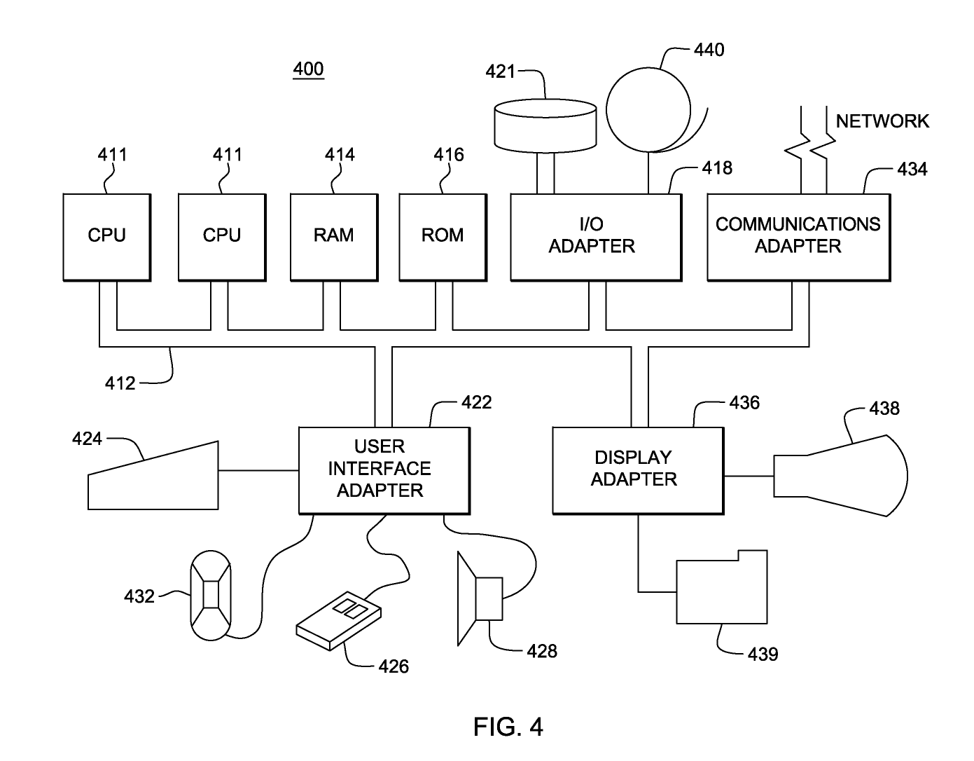

FIG. 4 illustrates an exemplary hardware configuration of a computing system 400 running and/or implementing the method steps described herein. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having thus described our invention, what we claim as new, and desire to secure by Letters Patent is:

1. A method for detecting who is a leader in an group of individuals comprising:
collecting data regarding interactions between individuals in said group; and,
for each individual i in the group and for each individual j who interacts with individual i, and, for each interaction between i and j, computing a relative leadership score λᵢⱼ describing a relationship between a leadership score lᵢ corresponding to individual i and, leadership score lⱼ corresponding to individual j, and,
computing, based on said relative leadership scores, an individual leadership score lᵢ, lⱼ corresponding to each individual i and j, a leader of said group determined as an individual having a largest leadership score at a given time,
wherein a program using a processor unit executes one or more said collecting, computing and determining.

2. The method as in claim 1, wherein said computing a relative leadership score λᵢⱼ comprises:
computing a contribution of each interaction to said relative leadership score as a function of a time period t_{sender, recipient} in which recipient j responds to an interaction initiated by sender i.

3. The method as in claim 2, wherein said computing a relative leadership score λᵢⱼ further comprises:
computing a contribution of each interaction to said relative leadership score as a function of an average response time θ_{recipient} in which the recipient/ responds to all interactions initiated by senders.

4. The method as in claim 2, wherein said computing a relative leadership score λᵢⱼ further comprises: determining a weight contribution of each interaction to a relative leadership score between individual i and j, said λᵢⱼ representing an average weight over all the interactions between individuals i and j.

5. The method as in claim 4, wherein said determining of leadership scores comprises:
iteratively processing a set of linear equations in lᵢ to minimize a difference between lᵢ and lⱼ, where
lᵢ≈λᵢⱼlⱼ.

6. The method as in claim 3, wherein said collecting data comprises:
recording a time a first individual i of said entity initiates an interaction via a computer device; and,
recording a time tᵢⱼ it takes for a second individual j of said group to respond to said interaction initiated by first individual i, said second individual j having an average response time θⱼ for computer based interactions initiated by other individuals; said method further comprising:
updating an associated leadership score of said individuals i, j, wherein said leadership score of said first individual i relative to said second individual j is a function of tᵢⱼ/θⱼ.

7. The method as in claim 6, wherein said collecting data further comprises:
recording, by said processor unit, a time t1 that the individual i's action started.
recording, by said processor unit, a time t2 that the individual i's action became observable to one or more second individuals; and,
recording, by said processor unit, a time t3 that the second individual observed the individual i's action, wherein time tᵢⱼ represents a response time for an individual j to initiate a response to action of individual i is t3−t1,
wherein said updating of said leadership score is based on said tᵢⱼ.

8. The method as in claim 7, further comprising:
determining whether an individual i's action is a response to a previous action by another individual j, and, if said individual i's action is a response to a previous action of individual j, then recording said time tᵢⱼ it takes the individual j to initiate a response, and updating a leadership weight based on the relative response time tᵢⱼ, wherein tᵢⱼ=t3−t1.

9. The method as in claim 1, wherein an interaction by sender and recipient individuals comprises: an e-mail communication to a recipient, a chat initiated with recipient, or phone interaction with recipient, or, a creating or changing of a software artifact, said method further comprising:
determining whether the interaction is sending an email and recording the time the message was received in a recipient's e-mailbox or voice mailbox; or,
determining whether the interaction is the creation or change of some software artifact and recording the time that the artifact is committed to the public domain.

10. The method as recited in claim 1, further comprising: determining a type of leader by:
considering a type of the action which is taken by a user; and
comparing response times of individuals for the same kind of action,
wherein a leader corresponding to each action is determinable based on the response time comparison.

11. The method as recited in claim 1, further comprising:
determining availability of information about relevance of a response; and,
modifying a weight of each individual response based on the available information,
whereby in absence of information about the relevance of a response, giving more weight to responses from other past or current leaders.

12. The method as in claim 1, wherein, after determining an individual leader in the group:
observing that individual leader's interaction patterns within the entity and comparing them with a pattern involving leadership, and
reporting information about the comparisons.

13. A system for detecting who is a leader in an group of individuals, the system comprising:
a memory;
a processor unit in communication with the memory that performs a method comprising:
collecting data regarding interactions between individuals in said group; and,
for each individual i in the group and for each individual j who interacts with individual i, and, for each interaction between i and j, computing a relative leadership score λᵢⱼ describing a relationship between a leadership score lᵢ corresponding to individual i and, leadership score lⱼ corresponding to individual j, and,
computing, based on said relative leadership scores, an individual leadership score lᵢ, lⱼ corresponding to each individual i and j, a leader of said group determined as an individual having a largest leadership score at a given time.

14. The system as in claim 13, wherein said computing a relative leadership score λᵢⱼ comprises:
computing a contribution of each interaction to said relative leadership score as a function of a time period t_{sender, recipient} in which recipient j responds to an interaction initiated by sender i.

15. The system as in claim 14, wherein said computing a relative leadership score λᵢⱼ further comprises:
computing a contribution of each interaction to said relative leadership score as a function of an average response time θ_{recipient} in which the recipient j responds to all interactions initiated by senders.

16. The system as in claim 14, wherein said computing a relative leadership score λᵢⱼ further comprises: determining a weight contribution of each interaction to a relative leadership score between individual i and j, said λᵢⱼ representing an average weight over all the interactions between individuals i and j.

17. The system as in claim 16, wherein said determining of leadership scores comprises:
iteratively processing a set of linear equations in lᵢ to minimize a difference between lᵢ and lⱼ, where
lᵢ≈λᵢⱼ lⱼ.

18. The system as in claim 15, wherein said collecting data comprises:
recording a time a first individual i of said group initiates an interaction via a computer device; and,
recording a time tᵢⱼ it takes for a second individual j of said group to respond to said interaction initiated by first individual i, said second individual j having an average response time θⱼ for computer based interactions initiated by other individuals; and,
updating an associated leadership score of said individuals i, j, wherein said leadership score of said first individual i relative to said second individual j is a function of tᵢⱼ/θⱼ.

19. The system as in claim 18, wherein said collecting data further comprises:
recording, by said processor unit, a time t1 that the individual i's action started.
recording, by said processor unit, a time t2 that the individual i's action became observable to one or more second individuals; and,
recording, by said processor unit, a time t3 that the second individual observed the individual i's action, wherein time tᵢⱼ represents a response time for an individual j to initiate a response to action of individual i is t3−t1,
wherein said updating of said leadership score is based on said tᵢⱼ.

20. The system as in claim 19, wherein said method further comprises:
determining whether an individual i's action is a response to a previous action by another individual j, and, if said individual i's action is a response to a previous action of individual j, then recording said time tᵢⱼ it takes the individual j to initiate a response, and updating a leadership weight based on the relative response time tᵢⱼ, wherein tᵢⱼ=t3−t1.

21. The system as in claim 13, wherein an interaction by sender and recipient individuals comprises: an e-mail communication to a recipient, a chat initiated with recipient, or phone interaction with recipient, or, a creating or changing of a software artifact, said method further comprising:
determining whether the interaction is sending an email and recording the time the message was received in a recipient's e-mailbox or voice mailbox; or,
determining whether the interaction is the creation or change of some software artifact and recording the time that the artifact is committed to the public domain.

22. A computer program product for detecting who is a leader in an entity of individuals, the computer program product comprising:
a storage medium readable by a processing circuit and storing instructions for execution by the processing unit for performing a method comprising:
collecting data regarding interactions between individuals in said group; and,
for each individual i in the group and for each individual j who interacts with individual i, and, for each interaction between i and j, computing a relative leadership score λᵢⱼ describing a relationship between a leadership score lᵢ corresponding to individual i and, leadership score lⱼ corresponding to individual j, and,
computing, based on said relative leadership scores, a leadership score lᵢ, lⱼ corresponding to each individual i and j, a leader of said group determined as an individual having a largest leadership score at a given time.

23. The computer program product as in claim 22, further comprising:
computing a contribution of each interaction to said relative leadership score as a function of a time period t_{sender, recipient} in which recipient j responds to an interaction initiated by sender i;
computing a contribution of each interaction to said relative leadership score as a function of an average response time θ_{recipient} in which the recipient j responds to all interactions initiated by senders; and,
determining a weight contribution of each interaction to a relative leadership score between individual i and j, said λᵢⱼ representing an average weight over all the interactions between individuals i and j.

24. The computer program product as in claim 23, wherein said determining of leadership scores comprises:
iteratively processing a set of linear equations in lᵢ to minimize a difference between lᵢ and lⱼ, where
lᵢ≈λᵢⱼ lⱼ.
